(19) United States
(12) Patent Application Publication
(10) Pub. No.: US 2019/0136338 A1
(43) Pub. Date: May 9, 2019

(54) TEMPERATURE-CONTROL DEVICE FOR COMPONENTS

(71) Applicant: EBNER INDUSTRIEOFENBAU GMBH, Leonding (AT)

(72) Inventors: Robert EBNER, Leonding (AT); Ulrich PSCHEBEZIN, Ansfelden (AT)

(21) Appl. No.: 16/308,397

(22) PCT Filed: Jun. 7, 2017
(86) PCT No.: PCT/EP2017/063863

§ 371 Date: Dec. 7, 2018

(30) Foreign Application Priority Data
Jun. 9, 2016 (DE) 10 2016 110 677.1

(51) Int. Cl. C21D 9/34; C21D 1/58; C21D 1/613; C21D 1/667; F27B 9/08; F27B 9/10

(52) U.S. Cl. CPC C21D 9/34; C21D 1/58; F27B 9/10; C21D 1/667; F27B 9/082; C21D 1/613

(57) ABSTRACT

The present invention relates to a temperature-control device for controlling the temperature of a component part, in particular a wheel rim. The temperature-control device has a housing, in which an at least partly closed temperature chamber is formed, wherein the component part can be arranged in the temperature chamber. The temperature-control device further has a nozzle matrix having a plurality of nozzles, wherein a tempering medium can be flowed through the nozzles on the component part. The temperature-control device further has a control unit, which is coupled to the nozzle matrix. The control unit is configured to control a first group of nozzles of the nozzles and a second group of nozzles independent from each other, such that the first group of nozzles flows a first tempering medium having a first temperature-control characteristic and the second group of nozzles flows a second tempering medium having a second temperature-control characteristics on the component part.

### CROSS-REFERENCE TO RELATED APPLICATIONS

The present application is a national phase derived from the international patent application no. PCT/EP2017/063863, filed Jun. 7, 2017, which claims the benefits from the German patent application no. DE 10 2016 110 677.1, filed Jun. 9, 2016, both of which are incorporated herein by reference in their entirety.

### FIELD OF THE INVENTION

The present invention relates to a temperature-control device for component parts and a method for controlling the temperature of component parts.

### TECHNOLOGICAL BACKGROUND

In order to adjust desired component part properties in component parts, such as for example car wheel rims, these have, after the heating up, to be cooled down with a determined cooling rate. In a solution heat treatment (or solution annealing), the component parts are brought, for example, to a solution heat treatment temperature of approximately 540 degrees. Subsequently, the component parts are cooled down rapidly (or chilled) in a water quench (or water bath). In such a cooling down, areas of the component part may cool down partly inhomogeneously. Furthermore, by a chilling (or cooling down very rapidly) in the water quench, an area-wise cooling down of individual areas of the component part can be controlled only hardly.

### SUMMARY OF THE INVENTION

There may be a need to exactly control the temperature of areas of a component part during a thermal treatment.

This need is satisfied by a temperature-control device for controlling the temperature of a component part as well as by a method for controlling the temperature of a component part according to the independent patent claims.

According to a first exemplary embodiment of the present invention, there is described a temperature-control device for controlling the temperature (i.e. heating up, holding a temperature, or cooling down) of a component part (or element), in particular a wheel rim. The temperature-control device has a housing, in which an at least partly closed temperature chamber is formed, wherein the component part is arrangeable (or can be arranged) in the temperature chamber. The temperature-control device further has a nozzle matrix having a plurality of nozzles, wherein a tempering medium (or temperature-control medium) is flowable (or can be flowed) through the nozzles on the component part. Furthermore, the temperature-control device has a control unit, which is coupled to the nozzle matrix. The control unit is configured to control a first group of nozzles (or first nozzle group) having at least one nozzle of the nozzles and a second group of nozzles (or second nozzle group) having at least one nozzle of the nozzle independently from each other, such that the first group of nozzles flows a first tempering medium having a first temperature-control characteristics and the second group of nozzles flows a second tempering medium having a second temperature-control characteristics on the component part.

According to a further exemplary embodiment of the present invention, there is described a method for controlling the temperature of a component part, in particular a wheel rim. According to the method, a component part is arranged in a housing, in which an at least partly closed temperature chamber is formed. A first tempering medium having a first temperature-control characteristics is flowed on the component part by a first group of nozzles having at least one nozzle of nozzles of a nozzle matrix. A second tempering medium having a second temperature-control characteristics is flowed on the component part by a second group of nozzles having at least one nozzle of nozzles of the nozzle matrix. By a control unit, which is coupled to the nozzle matrix, the first nozzle group of the nozzles and the second nozzle group of the nozzles are controlled independently from each other.

The component part to be temperature-controlled may consist of a metallic raw material. For example, the component part may be a vehicle rim of metal and/or aluminium. Furthermore, the component part may, for example, represent a B-column for a vehicle. Generally, all component parts may be piece goods (e.g. forgings, castings and/or milled parts), which may be temperature-controllable (or can be temperature-controlled) by the temperature-control device according to the present invention, and in which different ductility properties and/or areas having different ductility properties may be desired and thus may have to be cooled down area-wisely with different cooling curves.

The housing may form an at least partly closed or completely closed temperature chamber. The housing may, for example, be formed as a hood and thus may cover for example the bottom area, on which the component part may be arranged. In other words, the housing can be put, for example, over the bottom area. Furthermore, the housing may form a completely closed temperature chamber. In this example, the temperature chamber may have at least one door element and/or one opening area, which can be opened and closed selectively, in order to bring in the component part into, or bring it out of, the temperature chamber.

In an exemplary embodiment, the housing may have a first wall and an, in particular arranged opposite to the first wall, second wall, which [together] may form the temperature chamber at least partly. Furthermore, in a further exemplary embodiment, the housing may have a ceiling and an, in particular arranged opposite to the ceiling, bottom, which [together] may form the temperature chamber at least partly.

The tempering medium may have a gaseous or a liquid state of aggregation. The temperature-control characteristics may describe, for example, the pressure, the temperature, the volume flow and/or the density of the tempering medium, in particular of the first tempering medium and of the second tempering medium.

In an exemplary embodiment example, the first tempering medium may differ from the second tempering medium, or alternatively, the first tempering medium and the second tempering medium may be the same. For example, the first tempering medium may be temperature-controlled differently than the second tempering medium. In a further exemplary embodiment, the first tempering medium may be a gaseous medium, in particular air or inert gas, and/or the second tempering medium may be a liquid medium, in particular water or oil.

The first tempering medium may differ materially from the second tempering medium, or may materially be the same. Furthermore, the first temperature-control characteristics may be different from the second temperature-control characteristics, or may be the same. If the control unit controls the first group of nozzles or the second group of nozzles with different cooling curves, the first group of nozzles and the second group of nozzles may flow an identical first and second tempering medium having the same temperature-control characteristics at a particular point in time. Furthermore, the control unit may control the groups of nozzles such that one of the groups of nozzles is inactive, so that no tempering medium may be flowed out of the nozzles and/or the nozzle of the inactive group of nozzles.

The nozzle matrix may refer to an arrangement of the plurality of nozzles. For example, an area of a nozzle matrix may have a nozzle formation, which may consist of, for example, four rows and four columns (4×4 matrix), or a further nozzle formation, which may consist of, for example, eight rows and eight columns (8×8 matrix). A nozzle matrix may consist of arbitrary numbers of rows and columns. Furthermore, in a nozzle matrix, the number of rows may differ from the number of columns. For example, a nozzle matrix may also consist of nozzles, which may be arranged in a plurality of concentric circles having different radii.

A group of nozzles (or nozzle group) may describe one nozzle or plural nozzles, which together may flow out the same tempering medium having the same temperature-control characteristics, and which may be controlled as a unit by the control unit. A group of nozzles may be formed from a fixed number of nozzles. Furthermore, a group of nozzles may be defined variably by the control unit, such that during an operation of the temperature-control device and/or during a temperature-control process of the component part, different nozzles may belong, in different numbers, to a particular group of nozzles.

In an exemplary embodiment, the nozzles may be coupled to a conveying device, such as for example a fluid pump or a ventilator, in order to convey the tempering medium in (or with) a desired temperature-control characteristics to the nozzles. For example, the first group of nozzles may be coupled to a first fluid pump and/or a first ventilator, and the second group of nozzles may be coupled to a second fluid pump and/or a second ventilator. The control unit may control the first fluid pump and/or the first ventilator and the second fluid pump and/or the second ventilator independently from each other. Accordingly, a first temperature-control device may be provided for controlling the temperature of the first tempering medium, and a second temperature-control device may be provided for controlling the temperature of the second tempering medium, wherein the temperature-control devices are controllable individually by the control unit. In addition or alternatively, there may also be arranged a valve arrangement, which may control selectively a volume flow of the first tempering medium and/or of the second tempering medium by the control unit. For each desired area of the component part, particular nozzles may be integrated flexibly as a first or a second group of nozzles, in order to perform a desired temperature-control of the area of the component part. The control unit may prescribe particular temperature-control sequences for each group of nozzles, and accordingly may flow a particular tempering medium having a desired temperature-control characteristics on the component part.

The first group of nozzles of the nozzles thus may stream against a first area of the component part with a first tempering medium having a first temperature-control characteristics, and the second group of nozzles of the nozzles may stream against a second area of the component part with a second tempering medium having a second temperature-control characteristics. For example, the first area of the component part may be held at a defined temperature, while the second area of the component part may be cooled with a predetermined cooling rate, in particular is chilled. The first group of nozzles and the second group of nozzles may be controlled such that a holding of the temperature, a heating up and a cooling down of the area of the component part that may be streamed against may be effected flexibly by the control unit. Furthermore, the cooling medium may be applied continuously or intermittently during a defined period of time through the nozzles on the areas of the component part.

By the temperature-control device according to the invention, the heat transfer (and thus the cooling rate, the holding rate or the heating rate) on desired areas of the component part, e.g. the wheel rim, may be defined precisely by controlling e.g. the pressure or the temperature as the temperature-control characteristics and/or the amount of the individual nozzles (for example of the first group of nozzles or the second group of nozzles). Due to the flexible assignment of the nozzles to particular groups of nozzles, also different component parts having different shapes may be cooled down selectively by the temperature-control device. Complex mechanical reconstructions (or rebuildings) of the temperature-control device for controlling the temperature of different component parts may not be necessary. In the temperature-control of a same or different component parts having different temperature-control areas, the control unit may subdivide new first and second groups of nozzles, without structural (or constructive) reconfigurations being necessary.

As is explained and indicated in the following, the nozzle matrix may be subdivided into an arbitrary number of groups of nozzles and may be assigned to the control unit. Furthermore, as is mentioned below, plural nozzle matrices may be employed.

According to a further exemplary embodiment, the first group of nozzles may be formed at the first wall, and the second group of nozzles may be formed at the second wall. According to a further exemplary embodiment, the first group of nozzles and the second group of nozzles may be formed at the first wall.

According to a further exemplary embodiment, the housing may have a ceiling and an, in particular arranged opposite to the ceiling, bottom, which [together] form the temperature chamber at least partly. The first group of nozzles may be formed at the ceiling, and the second group of nozzles may be formed at the ceiling or the bottom.

According to a further exemplary embodiment, the housing may have a door element, which may form the temperature chamber at least partly. The door element may selectively open and close the temperature chamber, in order to convey the component part into the temperature chamber or out of the temperature chamber. The first group of nozzles and/or the second group of nozzles may be formed at the door.

In an exemplary embodiment, the temperature chamber may be formed of four sidewalls, of which one sidewall has the door element, and may in addition be closed at least with a ceiling (ceiling wall part). A group of nozzles may be formed respectively at the sidewalls as well as at the ceiling, wherein the control unit may flow out a respective tempering medium having a predetermined temperature-control characteristics at each group of nozzles. Furthermore, the temperature chamber may be formed with the bottom, wherein the bottom may also form (or may have) a group of nozzles. In a corresponding exemplary embodiment, the component part may thus be applied with a tempering medium to the full extent, wherein each side of the component part may be applied with an individual temperature-control characteristics (for example cooling characteristics).

According to a further exemplary embodiment, the temperature-control device may have a further nozzle matrix having further nozzles, wherein a further tempering medium may be flowable (or can be flowed) through the nozzles on the component part. The control unit may be coupled to the further nozzle matrix, and may be configured to control a further first group of nozzles of the further nozzles and a further second group of nozzles of the further nozzles independently from each other, such that the further first group of nozzles may flow a further first tempering medium having a further first temperature-control characteristics and the further second group of nozzles may flow a further second tempering medium having a further second temperature-control characteristics on the component part.

According to a further exemplary embodiment, the temperature-control device further may have a further housing, which may surround the housing, wherein a flow channel may be formed between the housing and the further housing. At least one fluid conduit may traverse the flow channel and may be coupled to the nozzles of the nozzle matrix, in order to supply the nozzles with the first tempering medium and/or the second tempering medium. A third tempering medium may be flowable through the flow channel for controlling the temperature of the fluid conduit.

The third tempering medium may, for example, be water, air, gas, or oil. The third tempering medium may control the temperature of the housing wall, so that a basic temperature may thus be adjusted around the housing and thus the temperature chamber. Furthermore, the fluid conduits, which may traverse the flow channel, may be held at a desired temperature. Thus, the housing and the fluid conduits may be held at a predefined basic temperature, such that a previously precisely defined temperature-control characteristics of the corresponding first or second tempering medium may be flowed out of the corresponding groups of nozzles quicker and more efficiently. According to a further exemplary embodiment, the housing may have a fluid outlet, in particular having further nozzles, which may form a fluid communication between the flow channel and the temperature chamber, so that the third tempering medium may be flowable into the temperature chamber. For example, a constant basic temperature and/or basic streaming against the component part may thus be ensured by the third tempering medium. Subsequently, an according tempering medium having quickly changing first and second temperature-control characteristics may be flowed on the component part flexibly by the first group of nozzles and the second group of nozzles. Furthermore, the third tempering medium may also be flowed through the fluid outlet into the temperature chamber, such that the third tempering medium holds good as a carrier for the first and second tempering medium that may be flowed in through the first group of nozzles and the second group of nozzles. Thus, this may lead to an atomized spray principle, in order to sprinkle (or bedew) areas of the component part homogeneously and steadily, and accordingly to apply with desired temperature-control characteristics.

According to a further exemplary embodiment, the temperature-control device may have a conveying device, which may be formed to drive (or convey) the component part into the temperature chamber or out of the temperature chamber, wherein the conveying device may be coupled to the control unit such that the component part may be movable relative to the nozzles. The conveying device may represent, for example, a belt conveying device or a chain conveying device. Furthermore, the conveying device may consist of a conveying trolley, on which the component part may be located. The trolley may be conveyed into the temperature chamber or out of the temperature chamber via pulleys (or rolls). The control unit may control the driving of heading (or the drive) of the conveying device such that a predetermined relative movement between the component part and the nozzles may be adjustable precisely. Thus, predetermined areas of the component part may be moved selectively along predetermined nozzles with a predetermined velocity, such that also a controllable adjustability of the temperature-control and/or the course of the temperature-control of the component part may be adjusted.

According to a further exemplary embodiment, at least one of the nozzles may be adjustable relative to the component part such that an effuse angle of the nozzles and/or a distance between the nozzle and the component part may be adjustable. The distance between the nozzle and the component part as well as the effuse angle of the tempering medium out of the nozzle also influence the efficacy of the temperature-control and the temperature-control properties of the tempering medium. The at least one nozzle (or the total nozzle group) may, for example, be shifted manually in the direction of the component part, or be adjusted manually in its angle. For example, according bearings, such as for example a ball bearing, may be provided in a wall of the housing in order to adjust the nozzles. Furthermore, the nozzle or the group of nozzles may be adjusted relative to the component part via a drive axle (e.g. a shaft).

According to a further exemplary embodiment, the temperature-control device further may have an adjustment unit, which may be formed to adjust at least one of the nozzles relative to the component part. The adjustment device may be coupled to the control unit such that an effuse angle of the at least one nozzle and/or a distance between the at least one nozzle and the component part is adjustable. The nozzles may be fixed, for example, to servomotors of the adjustment device. The servomotors may represent, for example, small electric motors. The control unit may control the adjustment device selectively such that a controllable adjustability of the temperature-control and/or the course of the temperature-control of the component part may be adjusted thereby.

It is pointed out that the embodiments described herein represent only a limited selection of possible embodiment variants of the invention. Thus, it is possible to combine the features of individual embodiments with each other in a suitable manner, such that a plurality of different embodiments is to be considered as obviously disclosed for the skilled person with the explicit embodiment variants described herein. In particular, some embodiments of the invention are described by device claims and other embodiments of the invention are described by method claims. However, it will become clear to the skilled person upon reading this application that, unless it is stated otherwise, in addition to a combination of features, which belong to one type of a subject of invention, also an arbitrary combination of features, which belong to different types of subjects of inventions, is possible.

### SHORT DESCRIPTION OF THE DRAWINGS

Embodiment examples are described in the following for a further discussion and for a better understanding of the present invention in more detail with reference to the appended drawings. In the drawings:

FIG. 1 is a schematic illustration of a temperature-control device according to an exemplary embodiment of the present invention;

FIG. 2 is a schematic perspective illustration of a temperature-control device according to an exemplary embodiment of the present invention, in which the temperature chamber is formed in addition with a bottom area; and

FIG. 3 is a schematic illustration of a nozzle matrix in a wall of a temperature chamber according to an exemplary embodiment of the present invention.

### DETAILED DESCRIPTION OF EXEMPLARY EMBODIMENTS

Same or similar components in different drawings are provided with same reference numerals. The illustrations in the drawings are schematic.

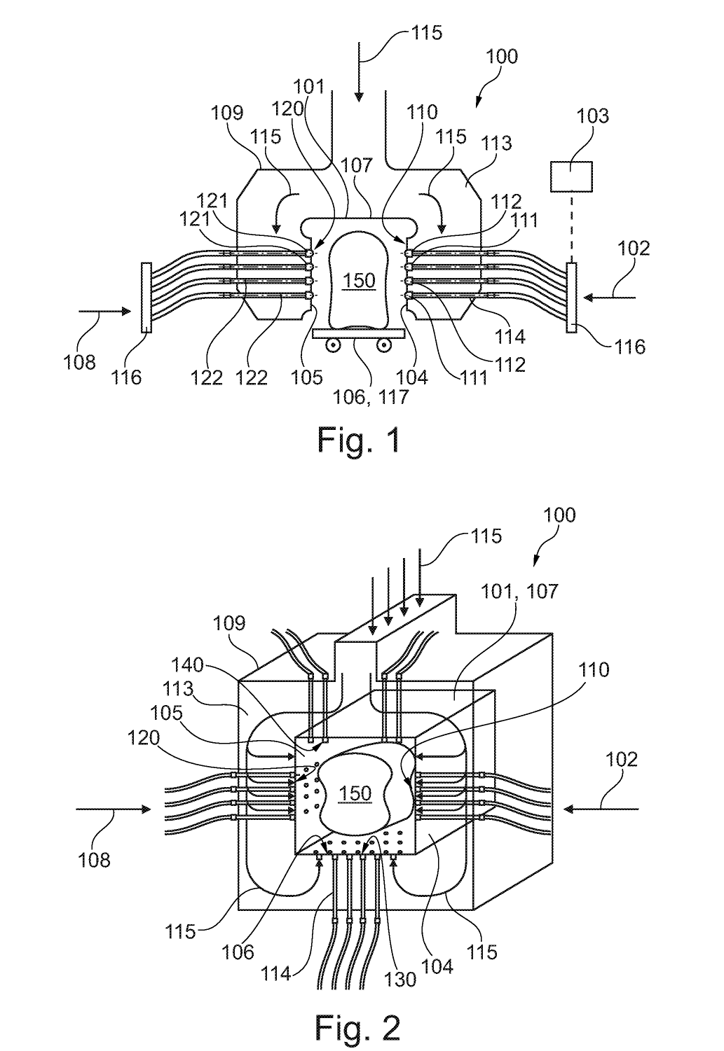

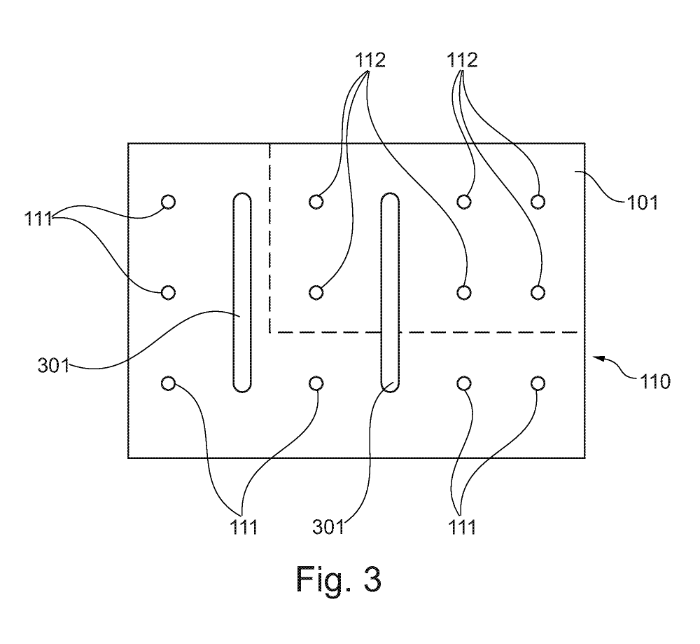

FIG. 1 and FIG. 2 show schematic illustrations of a temperature-control device 100 according to exemplary embodiments of the present invention. FIG. 1 shows, by difference to FIG. 2, a housing 101, which forms an open bottom area 106. FIG. 2 shows a housing 101, which forms a closed bottom area 106.

FIG. 1 and FIG. 2 show a temperature-control device 100 for controlling the temperature of a component part (or element) 150, in particular a wheel rim. The temperature-control device 100 may have a housing 101, in which an at least partly closed temperature chamber may be formed, wherein the component part 150 may be arrangeable in the temperature chamber. The temperature-control device 100 further may have a nozzle matrix 110 having a plurality of nozzles, wherein a tempering medium 102 may be flowable through the nozzles on the component part 150. Furthermore, the temperature-control device may have a control unit 103, which may be coupled to the nozzle matrix 110. The control unit 103 may be configured to control a first group of nozzles (or nozzle group) 111 of the nozzles and a second group of nozzles 112 of the nozzles independently from each other, such that the first group of nozzles 111 may flow a first tempering medium having a first temperature-control characteristics and the second group of nozzles 112 may flow a second tempering medium having a second temperature-control characteristics on the component part 150.

The housing may form an at least partly closed or fully closed temperature chamber. The housing 100 may be formed, for example, as a hood (FIG. 1) and may thus cover, for example, the bottom area 106, on which the component part 150 may be arranged. In other words, the housing 101 may for example be put over the bottom area 106. Furthermore, the housing may form a fully closed temperature chamber (FIG. 2). In this example, the temperature chamber may have at least one door element and/or an opening area, which can be opened and closed selectively, so as to bring the component part 150 into, or bring it out of, the temperature chamber.

The housing may have a first wall 104 and an, in particular arranged opposite to the first wall, second wall 105, which [together] may form the temperature chamber at least partly. The housing further may have a ceiling 107 and an, in particular arranged opposite to the ceiling 105, bottom 106, which [together] may form the temperature chamber at least partly.

The nozzle matrix 110 may refer to an arrangement of the plurality of nozzles. The nozzle matrix 110 may be arranged at the wall 104, and the further nozzle matrix 120 may be fixed at the wall 105. For example, an area of the nozzle matrix 110 may have a nozzle formation, which consists of, for example, four rows and four columns (4×4 matrix). A group of nozzles 111, 112, 121, 122 may describe a group of nozzles, which together may flow out the same tempering medium 102 having the same temperature-control characteristics and may be controlled as a unit by the control unit. A group of nozzles 111, 112, 121, 122 may be formed of a fixed number of nozzles. Furthermore, a group of nozzles 111, 112, 121, 122 may be defined variably by the control unit 103, such that during an operation of the temperature-control device 100 and/or during a temperature-control process of the component part 150, different nozzles in a different number may belong to a particular group of nozzles 111, 112, 121, 122.

The nozzles may be coupled to a conveying device, such as for example a fluid pump 116 or a ventilator, in order to convey (or transport) the tempering medium 102 to the nozzles in a desired temperature-control characteristics. For example, the first group of nozzles 111 may be coupled to a first fluid pump and/or a first ventilator, and the second group of nozzles 112 may be coupled to a second fluid pump and/or a second ventilator. The control unit 103 may control individually the first fluid pump and/or the first ventilator and the second fluid pump and/or the second ventilator independently from each other. Accordingly, a first temperature-control device for controlling the temperature of the first tempering medium and a second temperature-control device for controlling the temperature of the second tempering medium may be provided, wherein the temperature-control devices may be individually controllable by the control unit. In addition or alternatively, also a valve arrangement 116 may be arranged, which may selectively control a volume flow of the first tempering medium and/or of the second tempering medium by the control unit 103.

For each desired area of the component part, flexibly determined nozzles may be integrated as a first or a second group of nozzles 111, 112, in order to perform a desired temperature-control of the area of the component part. The control unit 103 may prescribe defined temperature-control sequences for each group of nozzles 111, 112, and accordingly may flow a defined tempering medium having desired temperature-control characteristics on the component part 150.

The first group of nozzles 111 of the nozzles thus may stream against a first area of the component part 150 with a first tempering medium having a first temperature-control characteristics, and the second group of nozzles 112 of the nozzles may stream against a second area of the component part 150 with a second tempering medium having a second temperature-control characteristics. For example, the first area of the component part 150 may be held at a defined temperature, while the second area of the component part 150 may be cooled with a predetermined cooling rate, in particular is chilled. The first group of nozzles 111 and the second group of nozzles 112 may be controlled such that a holding of the temperature, a heating up and a cooling down of the area of the component part that may be streamed against may be flexibly effected by the control unit 103.

The temperature-control device 100 may have a further nozzle matrix 120 having further nozzles, wherein a further tempering medium 108 may be flowable through the nozzles on the component part. The control unit 103 may be coupled to the further nozzle matrix 120, and may be configured to control a further first group of nozzles 121 of the further nozzles and a further second group of nozzles 122 of the further nozzles independently from each other, such that the further first group of nozzles 121 may flow a further first tempering medium having a further first temperature-control characteristics and the further second group of nozzles 122 may flow a further second tempering medium having a further second temperature-control characteristics on the component part.

As is illustrated in FIG. 1 and FIG. 2, one thus may control the temperature of component part areas of the component part 150 with different tempering media 102, 108 from opposite sidewalls 104, 105.

The temperature-control device 100 further may have a further housing 109, which may surround the housing 101, wherein a flow channel 113 may be formed between the housing 101 and the further housing 109. At least one fluid conduit 114 may traverse the flow channel and may be coupled to the nozzles of the nozzle matrix 110, 120, in order to supply the nozzles with the first tempering medium and/or the second tempering medium. A third tempering medium 115 may be flowable through the flow channel for controlling the temperature of the fluid conduit 114. For a better clarity, not all fluid conduits 114 illustrated in FIG. 1 and FIG. 2 between the nozzles and, for example, the pump arrangement and/or the valve arrangement 116 are provided with reference numerals.

The third tempering medium 115 may control the temperature of the housing walls 104, 105, 106, 107, so that thereby a basic temperature around the housing 101 and thus the temperature chamber can be adjusted. Furthermore, the fluid conduits, which may traverse the flow channel 113, may be held at a desired temperature.

In FIG. 1, furthermore, a conveying device 117 is illustrated, which may form the bottom 106 of the temperature chamber. The component part 150 may be coupled to the conveying device 117. The conveying device 117 may convey the component part out of the temperature chamber or into the temperature chamber, and also may selectively move the component part 150 during the temperature-control with according tempering media. The moving velocity and moving sequences may be controlled, for example, by the control unit 103.

FIG. 2 shows in particular a perspective illustration of a temperature-control device 100, wherein the housing 101 may surround the component part 150 to the full extent. For a better illustration, the cut-off walls in the front area and in the rear area of the temperature-control device are not represented. For example, a closable opening and/or a door device for selectively opening and closing may be arranged in these front and rear areas.

The nozzle matrix 110, which may form the first group of nozzles 111 and the second group of nozzles 112, may be arranged at the lateral wall 104. The further group of nozzles 120, which may have the further first group of nozzles 121 and the further second group of nozzles 122, may be formed at the opposite wall 105. For reasons of clarity, the according groups of nozzles in FIG. 2 are not provided with reference numerals.

Furthermore, also a further nozzle matrix 140 having according groups of nozzles may be arranged in the ceiling area 107, and a further nozzle matrix 130 having according groups of nozzles may be arranged in the bottom area 106.

The temperature chamber may thus be formed of four sidewalls 104, 105, of which one sidewall 104, 105 may have the door element, and may be closed in addition at least with one ceiling 107 (ceiling wall part). A nozzle matrix 110, 120 may be formed respectively at the sidewalls 104, 105 as well as at the ceiling 107, wherein the control unit 130 may flow out a respective tempering medium 102, 108 having a predetermined temperature-control characteristics at each group of nozzles 110, 120. Furthermore, the temperature chamber may be formed with the bottom 106, wherein the bottom 106 may also have a nozzle matrix 110, 120. The component part may thus be applied with a tempering medium to the full extent, wherein each side of the component part may be applied with an individual temperature-control characteristics (for example, cooling characteristics).

The housing 101 may further have a fluid outlet 301 (see FIG. 3), in particular having further nozzles, which may form a fluid communication between the flow channel 113 and the temperature chamber, such that the third tempering medium 115 may be flowable out into the temperature chamber. For example, a constant basic temperature and/or basic streaming against the component part 150 may be ensured with the third tempering medium 115. Subsequently, an according tempering medium 102, 108 having quickly changing first and second temperature-control characteristics may be streamed flexibly against (or flowed on) the component part 150. Furthermore, the third tempering medium 115 may also be flowed through the fluid outlet 301 into the temperature chamber, so that the third tempering medium 115 may hold good for a carrier for the first and the second tempering medium, which may be flowed in respectively through the first group of nozzles 111, 121 and the second group of nozzles 112, 122. Thus, this may lead to an atomized spray principle, so as to sprinkle areas of the component part 150 homogeneously and steadily, and accordingly apply with desired temperature-control characteristics.

An according conveying device 117, as is illustrated in FIG. 1, may be arranged also in the illustrated “to the full extent” temperature chamber.

FIG. 3 shows schematically a nozzle matrix 110 in a wall 101 of a temperature chamber according to an exemplary embodiment of the present invention. The nozzle matrix 110 may consist of twelve nozzles, which may be arranged in a 3×4 matrix. The nozzles of the first column as well as of the lowest row may form the first group of nozzles 111, and the remaining nozzles may form a second group of nozzles 112. The control unit 103 may individually control the nozzles of the first group of nozzles 111 and of the second group of nozzles 112.

Furthermore, by way of example, fluid outlets 301 are illustrated in the wall 101. As has been described above, a third tempering medium 115 may be flowed out through the fluid outlets 101. The third tempering medium 115 may flow out in a gaseous form such that an atomized spray may be formed, for example, [together] with the liquid tempering medium flowing in through the first or second group of nozzles 111, 112, in order to sprinkle the component part 150, and thus bring it to a desired temperature effectively and rapidly.

Supplementary, it is to be noted that “having” (or “comprising”) does not exclude other elements or steps, and that “a” or “an” does not exclude a plurality. Furthermore, it is to be noted that features or steps, which are described with reference to one of the above embodiment examples, can also be used in combination with other features or steps of other embodiment examples described above. Reference numerals in the claims are not to be considered as a limitation.

### LIST OF REFERENCE NUMERALS

100 temperature-control device
101 housing/temperature chamber
102 tempering medium
103 control unit
104 first wall
105 second wall
106 bottom
107 ceiling
108 further tempering medium
109 further housing
110 nozzle matrix
111 first group of nozzles
112 second group of nozzles
113 flow channel
114 fluid conduit
115 third tempering medium
116 pump arrangement/valve arrangement
117 conveying device
120 further nozzle matrix
121 further first group of nozzles
122 further second group of nozzles
130 further nozzle matrix
140 further nozzle matrix
150 component part
301 fluid outlet

1. Temperature-control device for controlling the temperature of a component part, in particular a wheel rim, the temperature-control device having:
a housing, in which an at least partly closed temperature chamber is formed,
wherein the component part is arrangeable in the temperature chamber,
a nozzle matrix having a plurality of nozzles,
wherein a tempering medium can be streamed through the nozzles on the component part,
a control unit, which is coupled to the nozzle matrix,
wherein the control unit is configured to control a first group of nozzles having at least one of the nozzles and a second group of nozzles having at least one of the nozzles independently from each other, such that the first group of nozzles flows a first tempering medium having a first temperature-control characteristics and the second group of nozzles flows a second tempering medium having a second temperature-control characteristics on the component part.

2. Temperature-control device according to claim 1,
wherein the housing has a first wall and a second wall, which is in particular opposite to the first wall, and wherein the first wall and the second wall form the temperature chamber at least partially.

3. Temperature-control device according to claim 2,
wherein the first group of nozzles is formed at the first wall, and the second group of nozzles is formed at the second wall.

4. Temperature-control device according to claim 2,
wherein the first group of nozzles and the second group of nozzles are formed at the first wall.

5. Temperature-control device according to claim 1,
wherein the housing has a ceiling and a bottom, which is in particular arranged opposite to the ceiling, wherein the ceiling and the bottom form the temperature chamber at least partly,
wherein the first group of nozzles is formed at the ceiling and the second group of nozzles is formed at the ceiling or at the bottom.

6. Temperature-control device according to claim 1,
wherein the housing has a door element, which forms the temperature chamber at least partly,
wherein the door element selectively opens and closes the temperature chamber, so as to convey the component part into the temperature chamber or out of the temperature chamber,
wherein the first group of nozzles and/or the second group of nozzles is formed at the door element.

7. Temperature-control device according to claim 1, further having
a further nozzle matrix having further nozzles,
wherein a further tempering medium is flowable through the nozzles on the component part,
wherein the control unit is coupled to the further nozzle matrix and is configured to control a further first group of nozzles of the further nozzles and a further second group of nozzles of the further nozzles independently from each other, such that the further first group of nozzles flows a further first tempering medium having a further first temperature-control characteristics and the further second group of nozzles flows a further second tempering medium having a further second temperature-control characteristics on the component part.

8. Temperature-control device according to claim 1,
wherein the first tempering medium differs from the second tempering medium, or
wherein the first tempering medium and the second tempering medium are the same.

9. Temperature-control device according to claim 1,
wherein the first tempering medium is a gaseous medium, in particular air or inert gas, and
wherein the second tempering medium is a liquid medium, in particular water.

10. Temperature-control device according to claim 1, further having
a further housing, which surrounds the housing,
wherein a flow channel is formed between the housing and the further housing,
wherein at least one fluid conduit traverses the flow channel and is coupled to the nozzles of the nozzle matrix, so as to supply the nozzles with the first tempering medium and/or the second tempering medium,
wherein a third tempering medium for controlling the temperature of the fluid conduit is flowable through the flow channel.

11. Temperature-control device according to claim 10,
wherein the housing has a fluid outlet, in particular having further nozzles, which forms a fluid communication between the flow channel and the temperature chamber, such that the third tempering medium is effusable into the temperature chamber.

12. Temperature-control device according to claim 1, further having
a conveying device, which is formed to convey the component part within the temperature chamber,
wherein the conveying device is coupled to the control until, such that the component part is movable relative to the nozzles.

13. Temperature-control device according to claim 1,
wherein at least one of the nozzles is adjustable relative to the component part, such that an effuse angle of the nozzles and/or a distance between the nozzle and the component part is adjustable.

14. Temperature-control device according to claim 13, further having
an adjusting device, which is configured to adjust at least one of the nozzles relative to the component part,
wherein the adjusting device is coupled to the control unit, such that an effuse angle of the at least one nozzle and/or a distance between the at least one nozzle and the component part is adjustable.

15. Method for controlling the temperature of a component part, in particular a wheel rim, the method having
arranging the component part in a housing, in which an at least partly closed temperature chamber is formed,
flowing a first tempering medium having a first temperature-control characteristics on the component part by a first group of nozzles having at least one nozzle of nozzles of a nozzle matrix, and
flowing a second tempering medium having a second temperature-control characteristics on the component part by a second group of nozzles having at least one nozzle of nozzles of the nozzle matrix,
wherein the first group of nozzles of the nozzles and the second group of nozzles of the nozzles are controlled independently from each other by a control unit, which is coupled to the nozzle matrix.
